(19) United States
(12) Patent Application Publication
(10) Pub. No.: US 2020/0117276 A1
(43) Pub. Date: Apr. 16, 2020

(54) PASSIVE HAPTIC FEEDBACK INPUT DEVICE

(71) Applicant: Carleton University, Ottawa (CA)

(72) Inventors: John C. McClelland, Toronto (CA); Robert J. Teather, Greely (CA); Audrey Girouard, Gatineau (CA)

(21) Appl. No.: 16/654,152

(22) Filed: Oct. 16, 2019

Related U.S. Application Data
(60) Provisional application No. 62/746,238, filed on Oct. 16, 2018.

(51) Int. Cl. G06F 3/01; G06F 3/0346

(52) U.S. Cl. CPC G06F 3/016; G06F 3/0346

(57) ABSTRACT

A passive haptic feedback device has a number of hinged panels that allow the device to be bent into a physical shape representative of a virtual object. Sensors associated with each of the hinges provide information indicative of the rotational configuration of the hinges and so the passive haptic feedback device.

### CROSS-REFERENCE TO RELATED APPLICATION

The current application claims priority to U.S. Provisional Patent Application 62/746,238 filed Oct. 16, 2018, the entire contents of which are incorporated herein by reference in their entirety for all purposes.

### FIELD OF THE INVENTION

The current disclosure relates to input devices for use in a virtual reality environment and in particular to passive haptic feedback input devices.

### BACKGROUND OF THE INVENTION

Passive haptic feedback uses physical objects or props to represent virtual object in a virtual environment. Passive haptic feedback may increase a user's immersion or sense of presence in a virtual environment as well as improve the user's task performance. However, providing passive haptic feedback for different objects in a virtual environment requires multiple different props.

While high cost systems, such as robotic force feedback systems may provide a wide range of haptic feedback for different objects in a virtual environment, their high costs and complexity make them limited in their application.

### BRIEF DESCRIPTION OF THE DRAWINGS

Features, aspects and advantages of the present disclosure will become better understood with regard to the following description and accompanying drawings in which:

FIG. 1 depicts a low cost passive haptic feedback system;

FIGS. 2A and 2B depict a low cost passive haptic feedback device; and

FIGS. 3A-3E depict different configurations of the passive haptic feedback device.

### DESCRIPTION OF THE INVENTION

In accordance with the present disclosure there is provided a passive haptic feedback device comprising: a plurality of planar panels; a plurality of hinges each hinge connecting adjacent planar panels together; a plurality of hinge configuration sensors, each hinge configuration sensor associated with a respective one of the plurality of hinges.

In accordance with a further embodiment of the passive haptic feedback device, each hinge configuration sensor outputs a signal indicative of a rotational position of the associated hinge.

In accordance with a further embodiment of the passive haptic feedback device, one or more of the plurality of hinge configuration sensors comprises one or more of: a rotary potentiometer; a rotary magnetic hall sensor; a rotary encoder; and a rotary inductive position sensor.

In accordance with a further embodiment of the passive haptic feedback device, one or more of the plurality of planar panels comprises: a controller receiving rotational position signals from the plurality of hinge configuration sensors.

In accordance with a further embodiment, the passive haptic feedback device further comprises a communication radio for communicating configuration information indicative of the rotational position of the plurality of hinges with a remote computer device.

In accordance with a further embodiment, the passive haptic feedback device further comprises a plurality of rotational actuators each associated with a respective one of the plurality of hinges.

In accordance with a further embodiment of the passive haptic feedback device, each of the rotational actuators are controllable to rotate the associated hinge.

In accordance with a further embodiment of the passive haptic feedback device, each of the hinge configuration sensors comprise an actuator controllable to rotate the associated hinge and output the signal indicative of the rotational position of the associated hinge.

In accordance with a further embodiment of the passive haptic feedback device, one or more of the plurality of planar panels further comprise one or more positional sensors for sensing a position or orientation of the passive haptic feedback device.

In accordance with a further embodiment of the passive haptic feedback device, the one or more positional sensors comprises one or more of: an accelerometer; a gyroscopic sensor; and a location sensor.

The passive haptic feedback device described herein provides a low cost device that can be used to provide passive haptic feedback for a variety of different objects or shapes in a virtual environment. The device provides physical approximations of different virtual objects and can provide realistic feedback to a user handling or interacting with an object in a virtual object. It is believed that human vision is the dominant sense for perceiving an environment and as such a physical representation of a virtual object seen by a user in a virtual environment does not need to be a highly realistic representation in order to provide useful haptic feedback to the user.

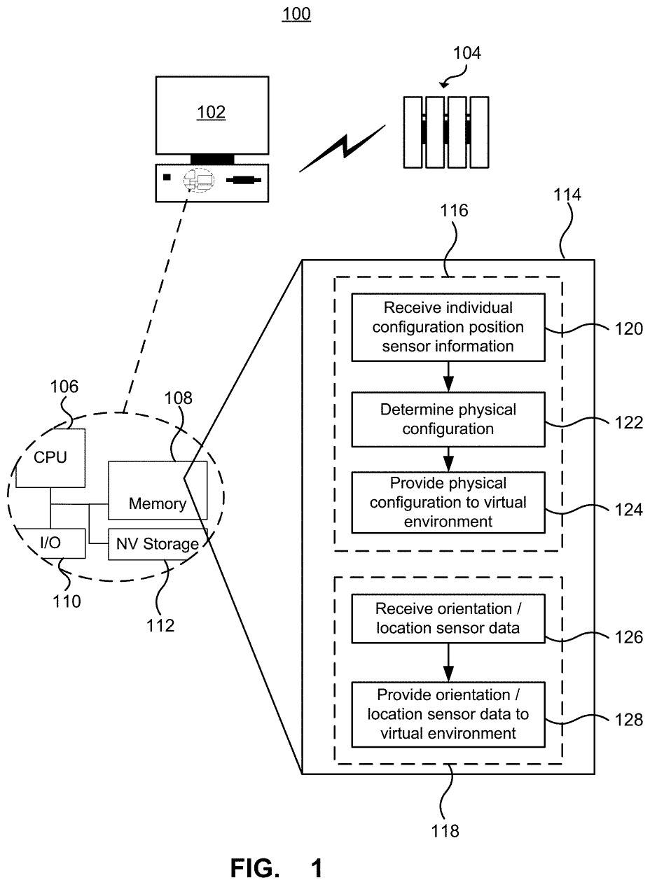

FIG. 1 depicts a low cost passive haptic feedback system. The system 100 comprises a computing device 102 that may be used to provide a virtual environment to a user. The system further comprises one or more passive haptic feedback devices 104 that can be configured to resemble the physical configuration of a virtual object. The passive haptic feedback device may provide input about the user's interactions with the virtual object, which can be reflected in the virtual environment. For example, as a user picks up, rotates, moves, etc. the passive haptic feedback device 104, a corresponding virtual object in the virtual environment may be picked up, rotated, moved, etc. The passive haptic feedback device 104 comprises a plurality planar panels that are joined together by a plurality of hinges that allow the passive haptic feedback device to be folded into a number of different shapes. The passive haptic feedback device 104 further includes a number of sensors for determining a rotational position of the hinges. The sensors can either communicate directly with the computing device 102, or with a controller or processor of the passive haptic feedback device 104.

The computer device 102 may comprise a central processing unit (CPU) 106 for executing instructions that configure the computer device 102 to provide various functionality, including for example providing the virtual environment. The computer device 102 may further comprise a memory unit 108 for storing data and instructions that can be executed by the CPU 106. The computer device 102 may further include an input/output (I/O) interface 110 that can be used to interface various components and devices to the computer device 102. The computer device 102 may further include non-volatile storage 112 for storing data as well as instructions.

The instructions stored in the memory 108 when executed by a processor such as CPU 106 can configure the device such as computer device 102 to provide various functionality 114. The functionality 114 may include configuration functionality 116 for determining the physical configuration of the passive haptic feedback device 104 as well location/orientation functionality 118 for providing information on the orientation and location of the passive haptic feedback device 104. Although both the configuration functionality 116 and the location/orientation functionality 118 are depicted as being provided by the computer device 102, it is possible for either one or both to be provided by a processor of the passive haptic feedback device 104.

The configuration functionality 116 receives individual configuration position information from the sensors associated with the hinges (120). Using the received position information, the configuration of the individual hinges can be determined and so the physical configuration of the passive haptic feedback device can also be determined (122). Once the physical configuration is determined, it can be provided to a virtual environment (124) in order to act as a physical representation of a virtual object. The location/orientation functionality 118 receives orientation/location sensor data (126) from one or more sensors capable of providing orientation and/or location information of the passive haptic feedback device. The received orientation and/or location information can be provided to the virtual environment (128) so that a user's interactions with the passive haptic feedback device representing the virtual object will be reflected in the virtual environment.

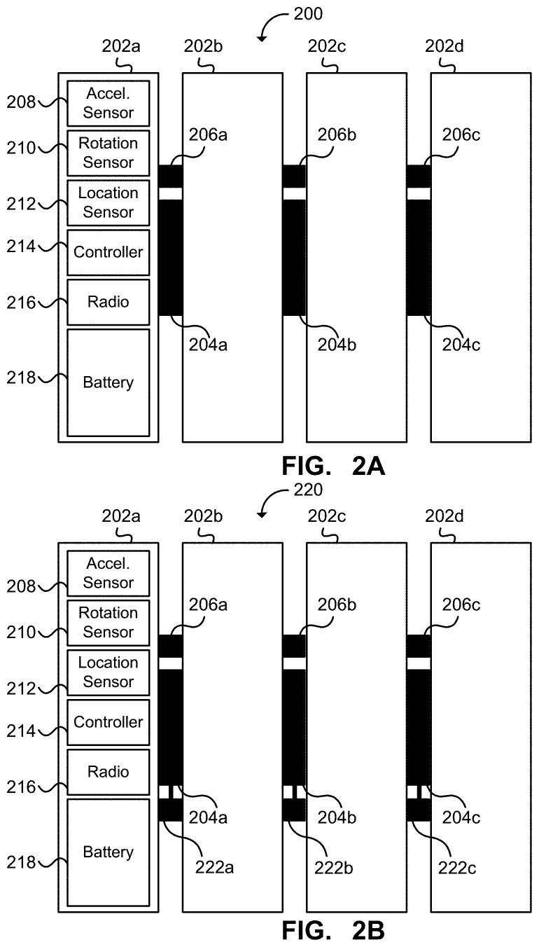

FIGS. 2A and 2B depict a low cost passive haptic feedback device. FIG. 2A depicts a first embodiment of the passive haptic feedback device 200. The device 200 is depicted as comprising a plurality of planar panels 202a, 202b, 202c, 202d (referred to collectively as planar panels 202) that are connected together by a plurality of hinges 204a, 204b, 204c, 204d (referred to collectively as hinges 204). Each of the hinges 204 is connected to adjacent planar panels 202. The hinges 204 may allow adjacent panels to rotate about single axis, such as in a common piano hinge. Alternatively, the hinges may be a link type of hinge which provides two axis points connected together by a hinge link. The link type of hinges may allow the adjacent planar panels to fold flat against each other. In the first embodiment 200 the hinges 204 may provide resistance against moving so that once positioned, they are not readily moved. This allows a user to configure the passive haptic feedback device into a desired configuration which the passive haptic feedback device will maintain while the user interacts with the virtual object represented by the configured passive haptic feedback device 200.

The passive haptic feedback device 200 further comprises a plurality of configuration position sensors 206a, 206b, 206c (referred to collectively as configuration position sensors 206) that are each associated with a respective one of the hinges 204. The configuration position sensors may be provided by various rotational sensing sensors including for example a rotary potentiometer, a rotary magnetic hall sensor, a rotary encoder, and a rotary inductive position sensor. Regardless of the particular type of sensor, each of the configuration position sensors provides information about a configuration of a portion of the passive haptic feedback device. From the configuration position sensor data the configuration angles between planar panels 202 can be determined. Since the physical size of each of the planar panels is known, once the configuration angles are known the configuration of the passive haptic feedback device 200 will also be known.

The passive haptic feedback device 200 may also comprise a number of additional components including, for example, one or more accelerometer sensors 208, rotational sensors 210 such as gyroscopic sensors as well as location sensors 212 which may provide information about the spatial location of the passive haptic feedback device 200. The passive haptic feedback device 200 may further include a controller 214 that can execute instructions for providing various functionality, including for example the configuration functionality 116 and the location/orientation functionality 118 described above with reference to FIG. 1. A radio communication module 216 may allow the passive haptic feedback device 200 to communicate with external computer devices using one or more wireless communication standards. The passive haptic feedback device 200 may also include a battery 218 for powering the various components of the device. Although the various components 208-218 are depicted as being housed within a single planar panel 202a, it will be appreciated that the components may be provided in different ones of the planar panels 202.

FIG. 2B depicts a second embodiment of a passive haptic feedback device 220. The passive haptic feedback device 220 is similar to that depicted in FIG. 2A and as such similarly numbered components are not described again in detail. In contrast to the passive haptic feedback device 220 which requires an individual to move or bend the passive haptic feedback device 200 into the desired configuration, the passive haptic feedback device 220 comprises a plurality of configuration actuators 222a, 222b, 222c (referred to collectively as configuration actuators 222) that are each associated with one of the hinges 204 and can controllably change the configuration angles in order to allow the shape of the passive haptic feedback device 220 to be changed and controlled by the controller 214 and/or an external computer device. For example, an external computer device may provide configuration angle information to the controller 214 specifying desired configuration angles between the planar panels 204. The configuration angle information can be provided in order to configure the passive haptic feedback device 220 into a configuration to represent a virtual object within a virtual environment provided by the external computer device. The configuration actuators 222 are depicted as being separate from the position configuration sensors 206, however it is contemplated that the configuration sensors 206 could be combined within the configuration actuators 222. In addition to enabling the configuration of the planar panels to be electronically controlled, the actuators 222 may also be used to lock the planar panels in the desired configuration. Additionally or alternatively, the actuators 222 may provide a controllable amount of resistance to moving by an individual in order to allow a user to change the configuration. For example, the passive haptic feedback device could be electronically configured to have a box shape, while some of the box joints could be locked in the box configuration, one joint could provide less resistance and so allow the user to move the joint as if the user is opening the box.

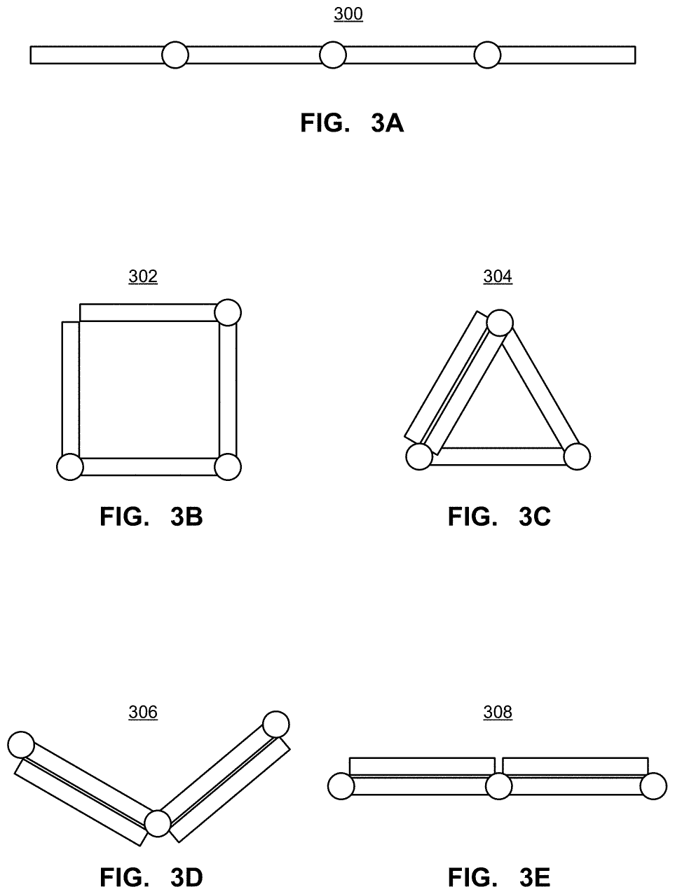

FIGS. 3A-3E depict different configurations of the passive haptic feedback device. Each configuration 300, 302, 304, 306, 308 may be provided by a single passive haptic feedback device, such as the passive haptic feedback devices described above. FIG. 3A depicts a flat configuration 302. FIG. 3B depicts a square or tubular configuration 302. FIG. 3C depicts a triangular configuration 306. FIG. 3D depicts a bent or book configuration 306. FIG. 3E depicts a small planar configuration 308. The configurations depicted in FIGS. 3A-3E are only illustrative and other configurations are possible. Further, by providing additional planar panels, additional configurations may be possible.

One or more illustrative embodiments have been described by way of example. It will be understood to persons skilled in the art that a number of variations and modifications can be made without departing from the scope of the invention as defined in the claims.

What is claimed is:

1. A passive haptic feedback device comprising:
a plurality of planar panels;
a plurality of hinges each hinge connecting adjacent planar panels together;
a plurality of hinge configuration sensors, each hinge configuration sensor associated with a respective one of the plurality of hinges.

2. The passive haptic feedback device of claim 1, wherein each hinge configuration sensor outputs a signal indicative of a rotational position of the associated hinge.

3. The passive haptic feedback device of claim 2, wherein one or more of the plurality of hinge configuration sensors comprises one or more of:
a rotary potentiometer;
a rotary magnetic hall sensor;
a rotary encoder; and
a rotary inductive position sensor.

4. The passive haptic feedback device of claim 1, wherein one or more of the plurality of planar panels comprises:
a controller receiving rotational position signals from the plurality of hinge configuration sensors.

5. The passive haptic feedback device of claim 4, further comprising a communication radio for communicating configuration information indicative of the rotational position of the plurality of hinges with a remote computer device.

6. The passive haptic feedback device of claim 4, further comprising a plurality of rotational actuators each associated with a respective one of the plurality of hinges.

7. The passive haptic feedback device of claim 6, wherein each of the rotational actuators are controllable to rotate the associated hinge.

8. The passive haptic feedback device of claim 4, wherein each of the hinge configuration sensors comprise an actuator controllable to rotate the associated hinge and output the signal indicative of the rotational position of the associated hinge.

9. The passive haptic feedback device of claim 4, wherein one or more of the plurality of planar panels further comprise one or more positional sensors for sensing a position or orientation of the passive haptic feedback device.

10. The passive haptic feedback device of claim 9, wherein the one or more positional sensors comprises one or more of:
an accelerometer;
a gyroscopic sensor; and
a location sensor.
